(19) United States
(12) Patent Application Publication
(10) Pub. No.: US 2018/0002982 A1
(43) Pub. Date: Jan. 4, 2018

(54) LADDER

(71) Applicant: DRESSEL DESIGNS, LLC, Everson, WA (US)

(72) Inventor: Marshall V.C. DRESSEL, Everson, WA (US)

(21) Appl. No.: 15/634,944

(22) Filed: Jun. 27, 2017

Related U.S. Application Data
(60) Provisional application No. 62/357,295, filed on Jun. 30, 2016.

(51) Int. Cl. E06C 7/16; E06C 7/18; E06C 1/06

(52) U.S. Cl. CPC E06C 7/16; E06C 1/06; E06C 7/183

(57) ABSTRACT

A ladder with increased stability during use is disclosed that includes support members that rotate into position to prevent the ladder from tipping or falling over during use. The support members may also provide a platform for temporary and secure storage of objects that are to be accessed before or after using the ladder, thus reducing the risk of injury to a user attempting to climb the ladder with an object to be accessed after climbing. The ladder further includes the capability to become mobile between uses or work locations by detaching from brackets or by not utilizing brackets at all. When not in use, the support members of the ladder rotate to align with the ladder in some embodiments or with bracket assemblies in other embodiments to further facilitate movement of the ladder and reduce the space required for storage.

### BACKGROUND

### Technical Field

The present disclosure relates to a ladder including features for stability during use, for mobility between uses, and for minimizing storage space when not in use.

### Description of the Related Art

Ladders are currently available in three general categories: leaning ladders, folding ladders, and hanging ladders. Leaning ladders are straight and are supported at an angle between a wall and the ground, while folding ladders are inverted at a vertex and supported against themselves for free-standing use next to and spaced from a wall, requiring only the ground for support. Hanging ladders, on the other hand, are typically supported from the top and extend towards the ground. For example, a hanging ladder may be built into a home and extend down from an opening in a ceiling, such as for access to an attic. While some ladders have features from more than one of these categories, ladders in the current market do not solve many of the issues faced by users. Each of these general categories provides advantages and disadvantages to potential users. Leaning and folding ladders are easy to move when changing locations, but have safety concerns. For example, the user's weight can cause the feet of the leaning ladder to slide on the ground away from the wall if the leaning ladder is not square to either surface. Furthermore, a user can easily tip over a folding ladder if the weight of the user is not equally distributed during use, or if the folding ladder is not evenly supported on the ground. In such a scenario, the risk of tipping significantly increases as the user climbs up to the higher steps of the ladder. In addition, the sliding and tipping risks of leaning and folding ladders, respectively, are greatly increased when using taller ladders.

While hanging ladders lower the risk of sliding or tipping compared to their leaning and folding counterparts, respectively, hanging ladders also have unique problems. In particular, hanging ladders are typically at least semi-permanently attached to a stationary surface (e.g., the top of the wall or a ceiling joist) and are therefore not easily moved between locations. In addition, hanging ladders can also be much more difficult to climb if the user must climb parallel, rather than at an angle, to a wall. Additionally, ladders that are designed for compact storage, such as those that fold up and are stored within an opening to an attic, can be flimsy and not sturdy.

Finally, all of these types of ladders are difficult to use while carrying an object. In many common scenarios, a user will attempt to climb any of the above categories of ladder while also holding an object that is to be accessed at the top of the ladder. In such a scenario, the added weight becomes harder to balance and the user may have trouble securing a grip on the ladder while the user's hand(s) are occupied with the object, thus increasing the probability of harm to the user and the held object.

### BRIEF SUMMARY

The embodiments described in the present application are directed to ladders that are easy to move and that stable during use, with rotating members that minimize the space required for storage when not in use. Such ladders provide a user with easy, stable access to, for example, an attic, a loft, an upper bunk of a bunk bed, (e.g., in their home) and to other items (e.g., in their home) that are higher than the user's reach, such as lights in a vaulted ceiling. Such ladders may provide a more stable and safer fire escape.

Some variations of these ladders are secured in use with bracket assemblies that are attached to a wall and support members that connect the ladder to the bracket assemblies. These bracket assemblies may be permanently attached to a wall in a user's home, workplace, etc., or in an environment such that the ladder can be easily moved and used in different locations within the environment. The bracket assemblies may be minimal such that the user is able to hide the brackets by hanging art, a mirror, or the like over the bracket assembly when not in use.

By providing a secured connection to a support surface, such as a wall, with such bracket assemblies, the risk of the ladder tipping or sliding during use is reduced significantly, if not completely. When not in use, the support members detach from the bracket assemblies, from the ladder, or both, and rotate to a position that increases ease of mobility of the ladder while minimizing the amount of space required for storage. In some variations, the support members can be secured to the bracket assemblies through use of pins or bolts. When in use, the pins or bolts secure the support members, and, by extension, the ladder to the bracket assembly to prevent the ladder from tipping or sliding. When the support member is rotated in order to store the ladder, the bolts may be used to secure the ladder to the bracket assembly through one or more holes in the bracket assemblies that align with holes in the corresponding support members.

Variations of these ladders provide similar benefits, without the use of bracket assemblies. The support members may be braced against the ladder to prevent sliding or tipping. In such embodiments, the absence of bracket assemblies provides the user with more freedom to use the ladder in a wider variety of locations and to move the ladder between locations.

Another variation of such a ladder includes a support platform at the top of the ladder. A support platform may be used to safely hold objects that the user wishes to access after climbing the ladder.

Other embodiments of a ladder may include a foldable or collapsible handrail that extends from the ladder to a comfortable position for the user to grasp while ascending or descending the ladder. During use, the handrail may be temporarily secured with a pin or other locking device to ensure safety and support. Such handrails may also be adjustable so that users of different heights can safely and conveniently use the handrail for assistance. When not in use, the locking device of the handrail can be released and the handrail may be folded or collapsed for storage next to the ladder. In some embodiments, the locking device may also be used to secure the handrail in the folded or collapsed position. Because the handrail is secured during use and collapses to minimize space during storage, the handrail may add further increase safety of the user without sacrificing other advantages of the system.

### BRIEF DESCRIPTION OF THE SEVERAL VIEWS OF THE DRAWINGS

In the drawings, identical reference numbers identify similar elements. The sizes and relative positions of elements in the drawings are not necessarily drawn to scale.

FIG. 1 is an isometric view of a system having first and second support members coupled to a ladder and secured to first and second bracket assemblies in a use position;

FIG. 2 is a side view of the system of FIG. 1 arranged in a storage position;

FIG. 3 is an isometric view of the system of FIG. 2 arranged in the storage position;

FIG. 4 is an isometric view of an alternative embodiment of a system according to an embodiment of the present disclosure having first and second support members removably coupleable with the ladder and arranged in a use position;

FIGS. 5A-5C are enhanced views of the system of FIG. 4;

FIG. 6 is an isometric view of a ladder having first and second supports coupled to the ladder with the second support supported by a brace member in a use position;

FIG. 7 is a side view of the ladder of FIG. 6 arranged in a storage position;

FIG. 8 is an isometric view of the ladder of FIG. 6 arranged in the storage position;

FIG. 9 is a partial rear view of the ladder of FIG. 6 having the second support temporarily secured to the ladder in the storage position;

FIGS. 10-12 are views of an alternative embodiment of a ladder according to embodiments of the present disclosure having an additional third support coupled to the second support and arranged in a use position;

FIGS. 13A-13B are partial side views of an alternative embodiment of a ladder according to embodiments of the present disclosure having a telescoping handrail arranged in a storage and a use position;

FIGS. 14A-14B are partial side views of an alternative embodiment of a ladder according to embodiments of the present disclosure having a slide and lock handrail arranged in a storage and in a use position;

FIG. 14C is a rear view of the handrail of the ladder in FIGS. 14A-14B showing the lock and release mechanism on the handrail

FIGS. 15A-15B are partial side views of an alternative embodiment of a ladder according to embodiments of the present disclosure having a cross and lock handrail arranged in a storage and a use position;

FIG. 16 is an isometric view of an alternative embodiment of a system having first and second support members coupled to a ladder and secured to first and second bracket assemblies in a use position;

FIG. 17 is an isometric view of the system of FIG. 16 arranged in a storage position;

FIG. 18 is a side view of the system of FIG. 16 arranged in the storage position;

FIG. 19 is an enhanced view of a first and second bracket assembly of the system of FIG. 16 showing a first support member coupled to the first bracket assembly;

FIG. 20 is an isometric view of an alternative embodiment of a system having first and second support members coupled to a ladder and secured to first and second bracket assemblies in a use position;

FIG. 21 is an isometric view of the system of FIG. 20 arranged in a storage position; and

FIG. 22 is a side view of the system of FIG. 20 arranged in the storage position.

### DETAILED DESCRIPTION

The present disclosure is directed to providing a stable ladder that is easily used and stored, such as within a user's home. Such a ladder is useful for accessing an attic of a home through an opening in the ceiling, accessing a loft, an upper bunk of a bunk bed, etc., as a replacement for traditional stairs (e.g., between floors or to access a roof), as a fire escape, and for other uses in a home or other environment. Existing ceiling mounted ladders are often wobbly and unsafe, and provide heightened safety risks when attempting to carry an item up the ladder, for example into an attic for storage. The ladders described in this application give users an easy, stable, compact, and storable ladder that can provide a storage space at the top of the ladder for placing objects that are to be accessed after climbing, while also reducing or eliminating the risks posed by current ladders in the art for similar uses. Other embodiments of the present disclosure may include a collapsible handrail that improves the safety of using the ladder without significantly increasing the space required to store the ladder when not in use.

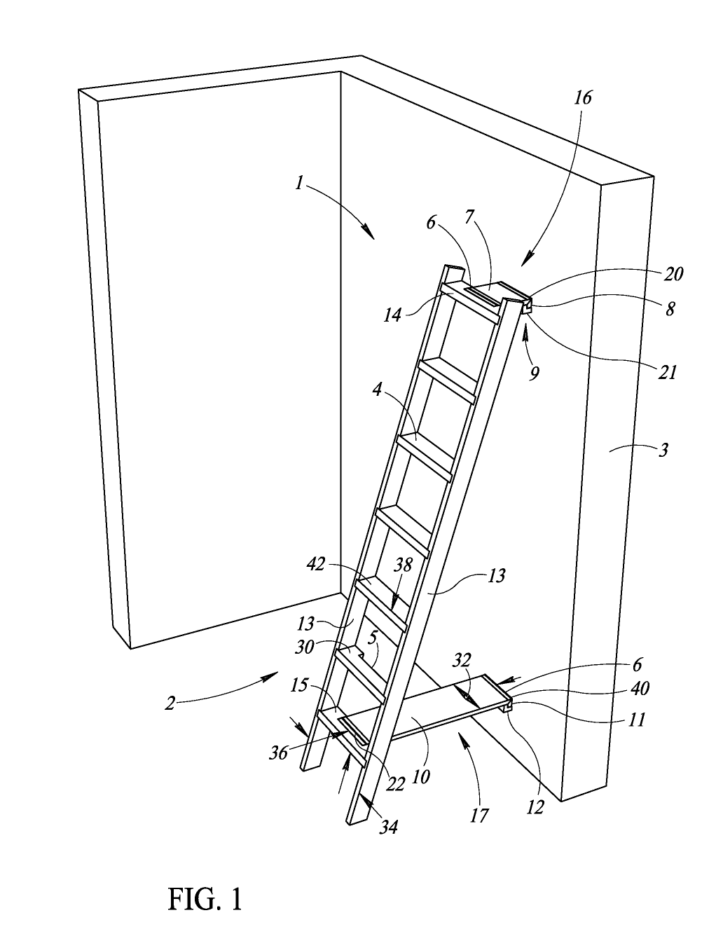

FIG. 1 is an embodiment of a system 1 that includes a ladder 2 that provides stability during use by being attached to a wall 3 through a first support member 16 and a second support member 17. The first support member 16 and the second support member 17 secure the ladder 2 to the wall 3 in order to prevent sliding and tipping of the ladder 2 during use, further reducing the risk of injury due while using the ladder 2. The first support member 16 forms a first platform 7 that provides the ability to securely store objects on the first platform 7 for access before and after using the ladder 2. A size of the first platform may be selected to offer a larger or smaller platform. Additionally or alternatively, a size of the first platform may be selected to align the ladder with a feature in the environment in which the ladder will be used, for example, an opening in a ceiling used to access an attic. In one embodiment, the first and second support members may be adjustable such that the platform may be expanded or contracted as the environment of use may need. As can be appreciated, both the first and second support members will be adjustable to maintain a consistent distance from the wall to maintain an appropriate angle of the ladder with respect to the ground.

As many users have experienced, it is challenging to transition from the steps of a typical ladder into the attic without an item in one's hands, and that challenge is increased, along with the risk of injury, by attempting to carry the item while climbing the steps. The first platform 7 not only provides the user with a stable location to support the item (e.g., a box) while the user is entering the attic, but also ensures that such item is easily accessible after entering the attic.

More specifically, the system 1 of FIG. 1 is in a use position that includes the ladder 2 having a pair of rails 13 and a plurality of steps 4 coupled to the pair of rails 13. The ladder 2 extends from the ground to the first support member 16. The first support member 16 provides support for the ladder 2 and the first platform 7 by including, in some embodiments, the first platform 7 coupled to an upper one 14 of the plurality of steps 4 by a hinge or rotation member 6. The hinge or rotation member 6 includes a stabilizing feature that stabilizes the first platform 7 during use by preventing the first platform 7 from rotating beyond a position substantially parallel to a top surface of the upper one 14 of the plurality of steps 4. The first support member 16 further includes a first connection member 8 coupled to the first platform 7 by a hinge or other suitable connection means 20. The hinge or rotation member 20 similarly includes a stabilizing feature that prevents the first platform 7 from rotating beyond a position substantially transverse to the first connection member 8, such that the rotation members 6, 20 keep the first platform 7 in a relatively stable and substantially immobile position during use. In one embodiment, the connection means 20 may be a fixed coupling between the first platform 7 and the first connection member, such that an angle between the two remains fixed during use and when not in use.

The first connection member 8 may be received by a first bracket assembly 9, such as a cleat, that is mounted to the wall 3, or other surface to provide support for the first support member 16. The first bracket assembly 9 contains a first receiving portion 21 that is substantially similar in shape and size to the first connection member 8 and allows the first connection member 8 to be removably coupleable to the first bracket assembly 9. The coupling of the first receiving portion 21 and the first connection member 8 secures the ladder 2 to the wall 3 to stabilize the system 1 during use and also provides the necessary support to the first platform 7 so that users can safely place objects on the first platform 7 for access before, during, and after climbing the ladder 2. A depth of an opening of the first bracket assembly corresponds to a dimension of the first connection member. This depth and dimension may be selected by the manufacturer to provide adequate support for the user's body weight and for an item that would be placed on the first platform.

The system 1 further includes the second support member 17 having a second platform 10 coupled to a lower one 15 of the plurality of steps 4 by a hinge or rotation member 22. The lower one of the steps may not be the lowest one of the steps. The hinge or rotation member 22 prevents the second platform 10 from rotating beyond a position parallel with a top surface of a lower one 15 of the plurality of steps 4. Alternatively, the hinge or rotation member may not prevent rotation past the position that is parallel with the top surface of the lower one of the steps and a second bracket assembly 12 stops the rotation of the second platform 10 during use.

The second platform 10 is further supported by a second connection member 11 that is coupled to the second platform 10 by a hinge or rotation member 24 that allows for the second connection member 11 to rotate to a position substantially transverse to the top surface of the lower one 15 of the plurality of steps 4. As noted above with respect to the first connection member, the second connection member may be coupled to the second platform in a fixed arrangement or may rotate through other means besides a hinge. When in the use position, the second connection member 11 may be received by the second bracket assembly 12, such as a cleat, that is mounted to a wall 3 or other surface. The second bracket assembly 12 contains a second receiving portion 23 that is substantially similar in size and shape to the second connection member 11, such that the second connection member 11 is removably coupleable to the second bracket assembly 12. As a result, the second support member 17 further secures the ladder 2 to the wall 3 to prevent sliding or tipping, and allows for safe use of the ladder 2 in a broader range of environments than other ladders. The ladder system described in FIG. 1 can be used wherever a first bracket assembly 9 and a second bracket assembly 12 are mounted, but other embodiments are possible that do not require the use of such assemblies.

In order to facilitate storage of the ladder in a compact manner, at least one 30 of the steps 4 includes an opening or grove 5 that is sized and shaped to receive the second platform 10 or first platform 7 when rotated up into the ladder. The platform has a first dimension 32 that is less than a first dimension 34 of the ladder. The platform has a second dimension 36 that is less than a second dimension 38 of the ladder so that an end 40 of the second platform 10 fits under a middle one 42 of the steps.

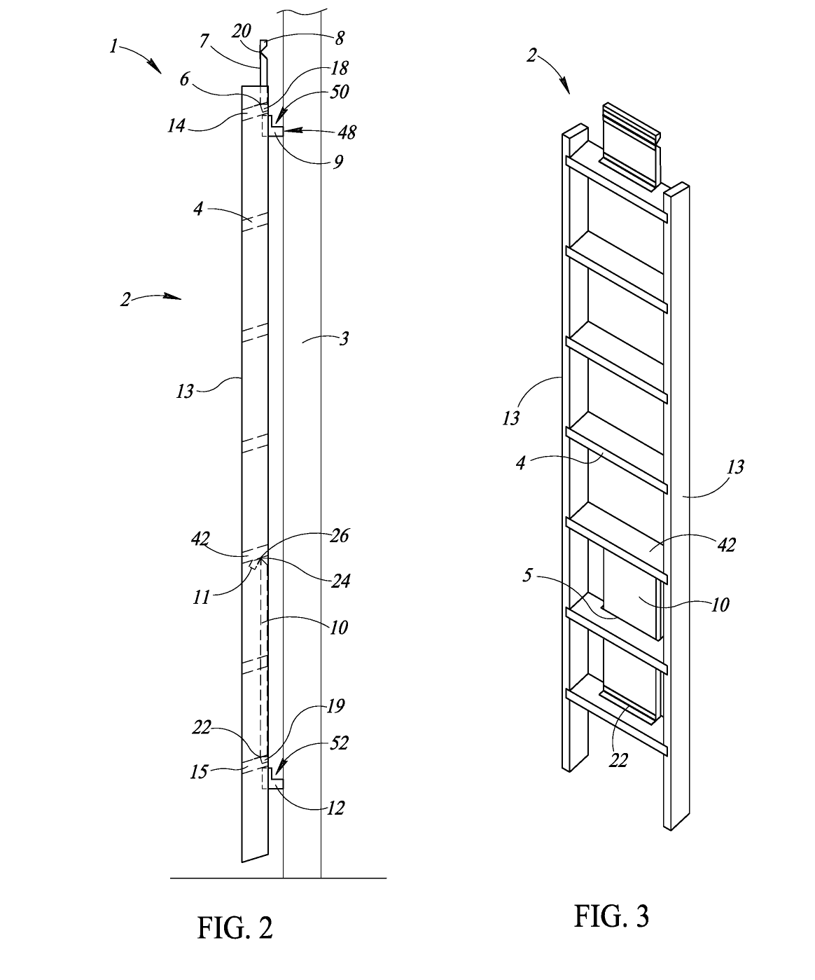

These differences in dimensions allows for the second platform 10 to fit within the ladder, as can be seen in FIGS. 2 and 3.

FIG. 2 shows the system 1 from FIG. 1 in a storage position that allows the user to minimize the amount of space required for storage of the system 1 while also demonstrating the mobility of the system 1. After use, the first connection member 8 can be removed from the first bracket assembly 9 and the second connection member 11 can be removed from the second bracket assembly 12. After removing the first connection member 8 and the second connection member 11, the user is free to move the ladder 2 to other locations for further use or to arrange the system 1 in the storage position. For storage, the first connection member 8 rotates about the hinge or rotation member 20 to a position substantially parallel with the first platform 7. The first platform 7 then rotates about the hinge or rotation member 6 to a position substantially transverse with the top surface of the upper one 14 of the plurality of steps 4. Similarly, the second connection member 11 rotates about the hinge or rotation member 24 to a position substantially parallel with the second platform 10 and the second platform 10 rotates about the hinge or rotation member 22 to a position substantially transverse to the top surface of the lower one 15 of the plurality of steps 4. In other embodiments, the second connection member 11 rotates about the hinge or rotation member 24 to a position substantially parallel with a bottom surface of one of the plurality of steps 4 such that the second connection member 11 can be secured to the bottom surface of one of the plurality of steps 4 by a clasp, magnet, or other temporary securing means 26. In this position, the ladder 2 not only becomes easier to move as the various components of the ladder 2 are substantially aligned with the pair of rails 13, but the first bracket assembly 9 and the second bracket assembly 12 may also be configured to receive the ladder 2, thus allowing the ladder 2 to be stored against the wall 3 where the first bracket assembly 9 and the second bracket assembly 12 are secured, further reducing the space required for storage of the system 1.

The ladder may, in some embodiments, include a first step support 18 and a second step support 19 on the steps 14, 15 that are configured to receive the first platform 7 and the second platform 10, respectively, when the system 1 is arranged for use. The first step support 18 provides support for the first platform 7, such that the first platform 7 is prevented from rotating beyond a position substantially parallel with the top surface of an upper one 14 of the plurality of steps 4 during use. As a result, the first step support 18 provides further support for the first platform 7 so that an object placed on the first platform 7 is supported by the rotation members 6, 20 as well as the first step support 18 of the upper one 14 of the plurality of steps 4. This arrangement provides the first platform 7 with the ability to support larger, heavier objects. Similarly, the second step support 19 prevents the second platform 10 from rotating beyond a position substantially parallel with the top surface of a lower one 15 of the plurality of steps 4. In the use position, the second step support 19 helps to integrate the system 1 so that the second platform 10 is further stabilized and supported by the lower one 15 of the plurality of steps 4, resulting in a further reduction of the risk of tipping or sliding.

As mentioned above, in other embodiments, such as the one displayed in FIG. 3, at least one of the plurality of steps 4 can include the storage opening or grove 5 that is configured to receive the second platform 10 by having a width and a depth substantially similar to the width and thickness of the second platform 10, respectively. When not in use, the second platform 10 rotates about the hinge or rotation member 22 and is received by the opening 5, which allows the second platform to substantially align with the pair of rails 13. In this position, the space required for storage is further minimized as the ladder 2 only requires enough space to store the pair of rails 13. In addition, having the second platform 10 substantially aligned with the pair of rails 13 increases mobility of the ladder 2 by providing for a more balanced load when the user moves the ladder 2 and by reducing the risk of hitting other objects in the environment of the ladder 2 as the user only has worry about hitting objects with the pair of rails 13 instead of also having concern over objects that could hit the second platform 10 in the use position.

In FIG. 2, the bracket assemblies 9, 12 extend from the wall 3 in a manner that allows the ladder, via the step 14 and the step 15 to rest and be supported by the bracket assemblies 9, 12. The user may opt to have more than one set of bracket assemblies 9, 12 positioned in their home or other environment, like office, garage, workshop, etc. The bracket assemblies can be fixedly attached to various walls for which ladder access is frequently needed, such as if there are multiple entrances to the attic. The bracket assemblies are designed to be small such that the user can hide these bracket assemblies behind art, a wreath, or other decorative item when the ladder is not in use. For example, a dimension 48 of the bracket assembly 9 may be in the range from three to six inches. The ladder and bracket assemblies may be sold as a kit that includes the ladder, the first and second support members and at least two of the first and second bracket assemblies.

In FIG. 2, the bracket assemblies 9,12 are L-shaped from a side with an opening 50, 52. Ends of these bracket assemblies may be open. In other embodiments, the ends are closed. In other embodiments, the dimension 48 of the first bracket assembly are sized and shaped to act as a floating shelf when not in use, such that it could support a picture frame or other decorative item.

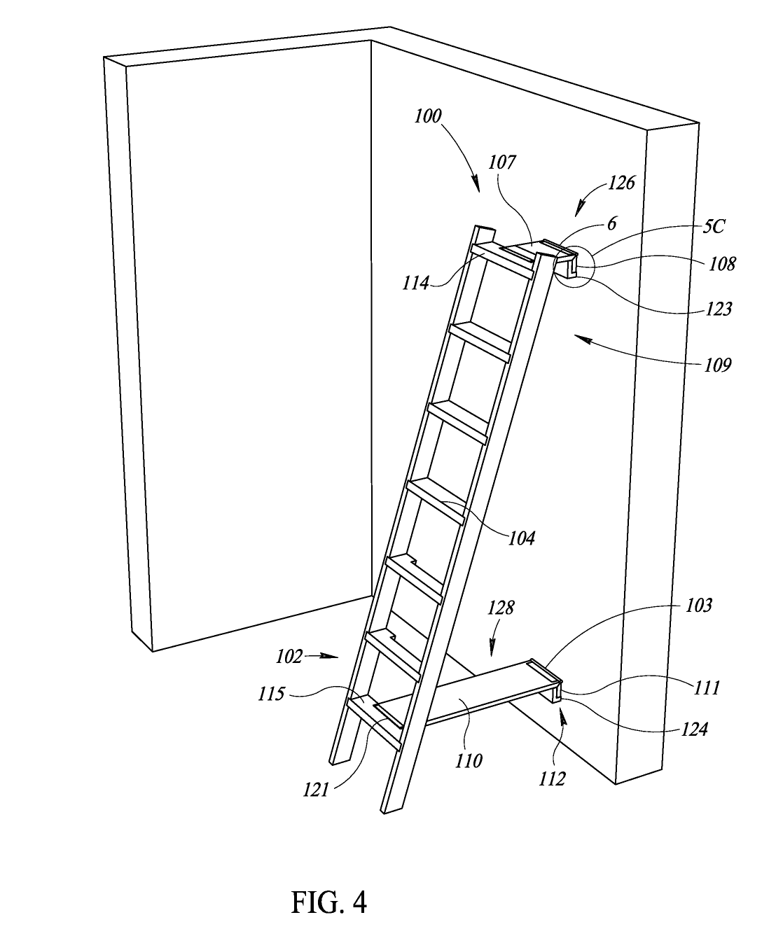

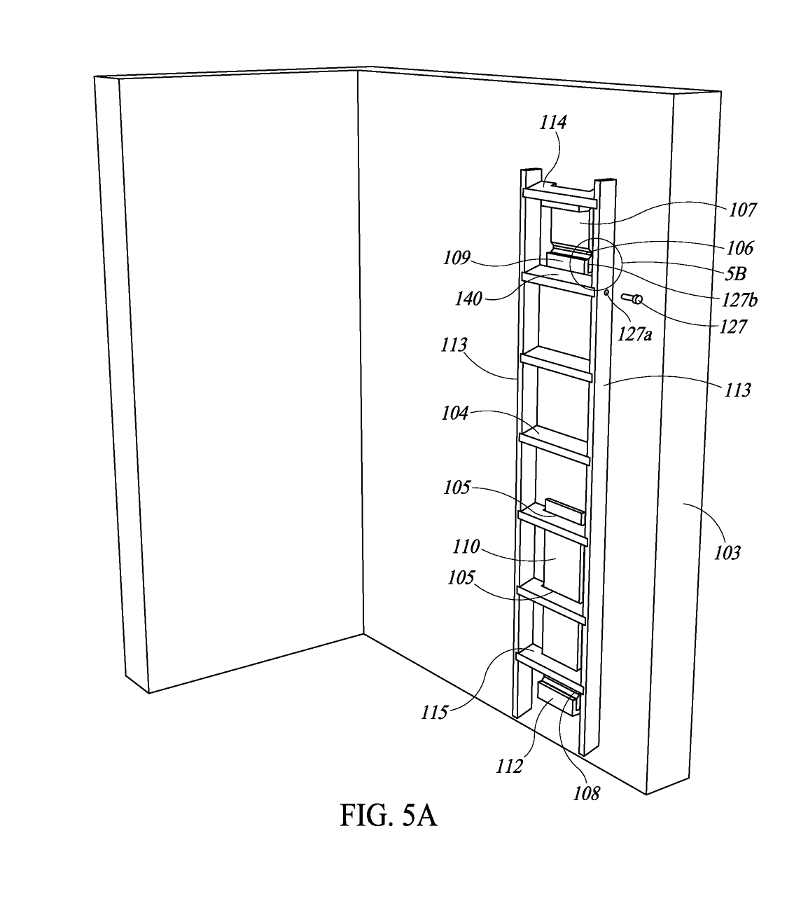

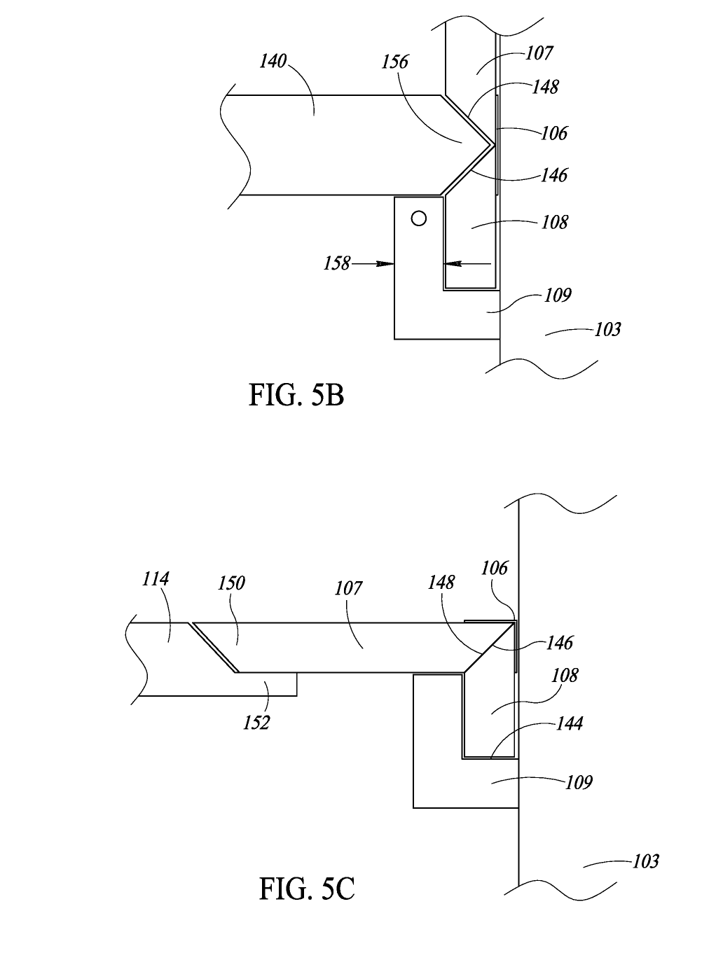

FIG. 4 is an alternative embodiment where a system 100 includes a ladder 102 having a first platform 107 and a second platform 110 that are removably coupleable from the ladder 102, which may increase mobility of the ladder 102 while also increasing the ease of storage of the system 100. The first and second platforms are part of first and second connection members 108, 110, which are configured to be detached from steps 114 and 115 and supported by bracket assemblies 109, 112 during storage, see FIGS. 5A-5C.

FIG. 4 shows a representative embodiment of the system 100 in a use position with the ladder 102 secured to a wall 103. The ladder 102 includes a first support member 126 having the first platform 107 coupled to a first connection member 108 by a hinge or other rotation member 106. The rotation member 106 can include a stabilizing feature that prevents the first platform 107 from rotating beyond a position substantially parallel to a top surface of an upper one 114 of a plurality of steps 104. In some embodiments, the first connection member 108 is removably coupleable to a first bracket assembly 109, while in others the first connection member 108 can be permanently coupled to the first bracket assembly 109. When in use, the first platform 107 rotates about the rotation member 106 and is received by a first step support 126. The first step support 126 is configured to have a width and thickness substantially similar to the width and thickness of the first platform 107. Once received, the first step support 126 stabilizes the first platform 107 and also provides support for the first platform 107 so that a user can safely place an object on the first platform 107 for access after climbing the ladder.

FIG. 5B is an enhanced view of the bracket assembly 109, the first connection member 108, and the first platform 107 in a storage position where a middle one 140 of the steps includes an angled end 156 that is sized and shaped to fit within the ends 146, 148 of the first connection member and the first platform and rest on the bracket assembly 109. A dimension 158 of the bracket assembly 109 can be selected to support the ladder with the middle one 140 of the steps. In an alternative embodiment, the bracket assembly 109 and the first connection member 108 may be one piece or may be fixedly attached to each other.

FIG. 5C is an enhanced view of the bracket assembly 109 attached to the wall 103, supporting the connection member 108. The connection member includes a first end 144 that rests within the bracket assembly 109 and a second end 146 that is angled. The rotation member 106 is positioned on a surface of the first connection member 108 and the first platform 107 that faces the wall 103. The first platform 107 includes a first end 148 that is angled and rests against the second end of the first connection member 108. The first platform 107 includes a second end 150 that is angled, but could be parallel to the wall, that is configured to rest and be supported by the step 114. The step 114 includes a grove or platform 152 that supports the second end of the platform.

The ladder 102 is further supported by a second support member 128 comprising a second platform 110 coupled to a second connection member 111 by a hinge or rotation member 108. The hinge or rotation member 108 stabilizes the system 100 by preventing the second platform 110 from rotating beyond a position substantially parallel with a top surface of a lower one 115 of the plurality of steps 104. In addition, the second connection member 111 may be removably coupleable to a second bracket assembly 112, or the second connection member 111 may be more permanently coupled to the second bracket assembly 112. The second bracket assembly 112 has a second receiving portion 124 with a size and shape substantially similar to the second connection member 111 so that the second bracket assembly 112 may easily receive the second connection member 111. During use, the second platform 110 is received by a second step support 121 that has a width and a thickness substantially similar to the second platform 110. The second step support 121 stabilizes the second platform 110 and secures the ladder 102 such that the ladder is at a lower risk of tipping or sliding during use. The coupling of the first platform 107 and the second platform 110 to the first step support 126 and the second step support 121, respectively, may be in some embodiments such that the first platform 107 and the second platform 121 are removably coupleable with the upper one 114 of the plurality of steps 104 and the lower one 115 of the plurality of steps 104, respectively. This removable coupling may also comprise temporary securing means such as slots, notches, magnets, clasps, or other items that provide additional support for the connection of the first platform 107 to the first step support 126 and the second platform 110 to the second step support 121 while not significantly increasing the difficulty of changing the system 100 from a use to a storage position.

When arranging the system 100 for storage, such as in FIG. 5A, the user removes the first platform 107 from the first step support 126 (FIG. 4) and the second platform 110 from the second step support 121 (FIG. 4). Once free, the first platform 107 rotates about the hinge or rotation member 106 to a position transverse to the top surface of the upper one 114 of the plurality of steps 104. In some embodiments (not shown), an end portion of the first platform 107 can rotate to a position substantially parallel with a bottom surface of the upper one 114 of the plurality of steps 104 to allow the first platform 107 to fit within the space between the plurality of steps 104 and the pair of rails 113 to reduce the amount of space required for storage. The ladder can be stored by resting on the end portion of the platform instead of on the bracket assembly.

Similarly, the second platform 110 is rotated about the hinge or rotation member 108 to a position substantially transverse to the top surface of the lower one 115 of the plurality of steps 104. At least one of the plurality of steps 104 can also include an opening or groove 105 that has a width and thickness substantially similar to the second platform 110 such that the second platform 110 can be received by the opening 105. In other embodiments, a removable fastener 127 (see FIG. 5A) may be provided to secure the rails 113 to the first bracket assembly 109. The rail 113 includes an opening 127a that receives the fastener 127 and the bracket assembly 109 includes an opening 127b that receives the fastener 127 via the rail 113, to hold the ladder in place during storage. In such arrangements, the first platform 107 is secured between the upper one 114 of the plurality of steps 104 and the wall 103 and the second platform 110 is similar secured between the opening 105 and the wall 103. By minimizing the number of pieces that must be moved prior to storage, the system 100 of this embodiment is easier to prepare for storage than some other embodiments. In addition, the weight of the ladder 102 is reduced by having the first platform 107 and the second platform 110 coupled with the first bracket assembly 109 and the second bracket assembly 112, respectively, during storage, which allows the user to more easily move the ladder 102 between work locations or from a use position to a storage position.

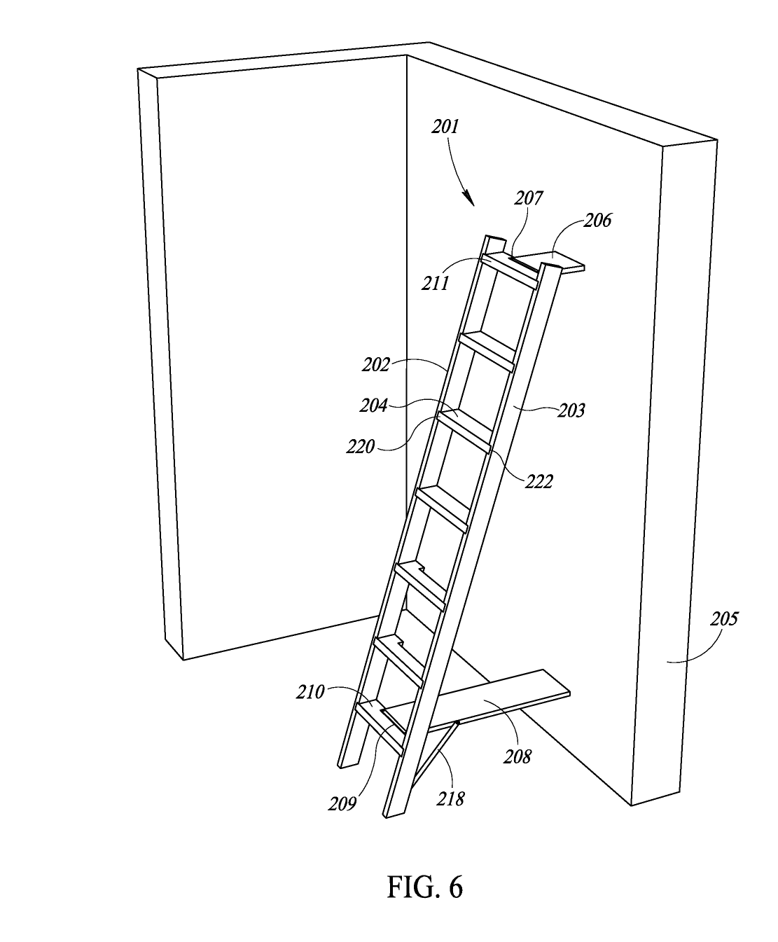

While bracket assemblies, such as those disclosed in earlier embodiments, have many advantages, it is also desirable from the user's perspective to obtain the advantages of a stable and secure ladder without relying on bracket assemblies. The absence of bracket assemblies provides the user with a different freedom to use the ladder in a wider variety of environments. For example, FIG. 6 shows a ladder 201 with a first support rail 202 positioned substantially adjacent and parallel to a second support rail 203. The ladder 201 contains a plurality of steps 204, with each of the plurality of steps 204 having a first end 220 coupled to the first rail 202 and a second end 222 coupled to the second rail 203. The ladder 201 also contains a first support 206 coupled to an upper one 211 of the plurality of steps 204 by a hinge or rotation member 207. The hinge or rotation member 207 allows the first support 206 to rotate to a position substantially parallel with the top surface of the upper one 211 of the plurality of steps 204, such that the first support can also serve as a platform for placing safely placing objects for use after climbing the ladder 201.

Similarly, a second support 208 is coupled to a lower one 210 of the plurality of steps 204 by a second hinge or rotation member 209. The hinge or rotation member 209 allows the second support 208 to rotate to a position substantially parallel with the top surface of the lower one 210 of the plurality of steps 204. While the hinge or rotation member 209 prevents the second support from rotating beyond that position, the second support 209 can also be supported by a brace member 218 that further couples the second support 208 to at least one of the first rail 202 or the second rail 203. The brace member 218 is configured to allow the second support 208 to rotate about the hinge or rotation member 209 while also preventing the second support 209 from rotating beyond the position parallel with the top surface of the lower one 210 of the plurality of steps 204. Although not visible in FIG. 6, there is a support brace 219 coupled between the ladder and the first support/platform 206. There may be one or two braces 218, 219 for each support 206, 208. Each brace 218, 219 is coupled to an interior surface of a respective rail 202, 203, see FIG. 9, such that in storage, the braces are positioned within the ladder. The braces attach to each support 206, 208 on a peg or other support that locks the brace into place during use. There may be a latch or other locking mechanism to hold the brace in place for stable support. The lower step 210 may include groves to hold the brace during storage or the braces may be sized and shaped to fit between two steps. Alternatively, the rails may have groves that are sized and shaped to receive the braces.

In some embodiments, the first support 206 and the second support 208 have a width substantially similar, but less than a width of the upper one 211 of the plurality of steps 204 and the lower one 210 of the plurality of steps 204, respectively. In this embodiment, the ladder 201 is prevented from sliding along a wall 205 or from tipping by the contact of the first support 206 and the second support 208 with the wall 205. Furthermore, the user may still use the first platform 206 as a secure location for storing objects, but by not relying on bracket assemblies, the user gains additional freedom to use the ladder 201 in more work locations where bracket assemblies are not appropriate.

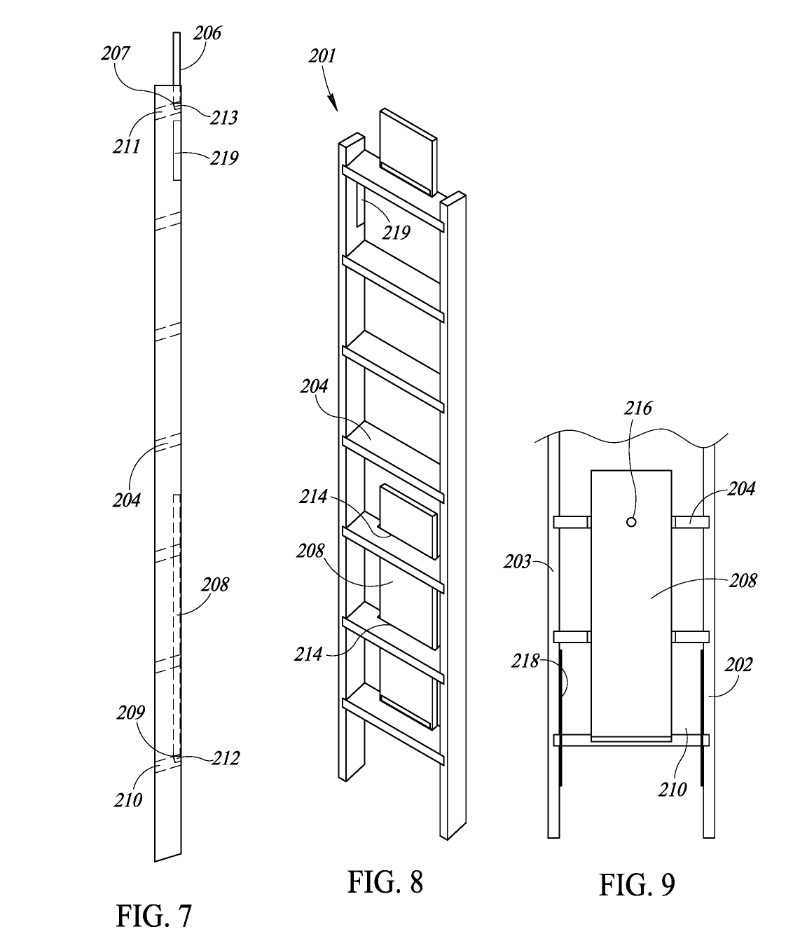

When the ladder 201 is not in use, such as is shown in FIG. 7, the user can rotate the first support 206 about the hinge or rotation member 207 to a position substantially transverse to the top surface of the upper one 211 of the plurality of steps 204 for storage. The storage position also exposes a first step support 213 that has a width and thickness substantially similar to the first support 206 so that the upper one 211 of the plurality of steps 204 can receive the first platform 206 at the first step support 213. Once secured, the first step support 213 prevents the first platform 206 from rotating beyond the parallel position and provides further support to the first platform 206. As a result, the first step support 213 which allows the user to safely place heavy objects on the first support 206 for access after climbing the ladder. Similarly, the second support 208 may also rotate at the hinge or rotation member 209 to a position substantially transverse to the top surface of the lower one 210 of the plurality of steps 204 for storage. Rotation exposes a second step support 212 that functions similarly to the first step support 213, only the second step support 212 is configured to receive and support the second platform 208.

FIG. 8 provides an isometric view of the ladder 201 of FIG. 7 and shows, in more detail, an embodiment featuring at least one notch 214 in at least one of the plurality of steps 204. The notch 214 has a width and a depth that is substantially similar the width and thickness of the second platform 208 so that the notch 214 can receive the second support 208 for storage. The notch 214 allows the second support 208 to rotate to a position substantially aligned with the ladder 201, which further reduces the amount of space necessary for storage of the ladder 201 and also allows the ladder to be more easily moved.

In some embodiments, a clasp, magnet, or other temporary security means 216 may be included, as shown in FIG. 9, to secure the second support member 208 to at least one of the plurality of steps 204 to prevent rotation of the second support member 208 when the ladder 201 (FIG. 8) is not in use. By securing the second platform 208, the user can more easily move the ladder 201 (FIG. 8) between work locations without fear of the second support 208 swinging away from the plurality of steps 204 and causing damage or injury.

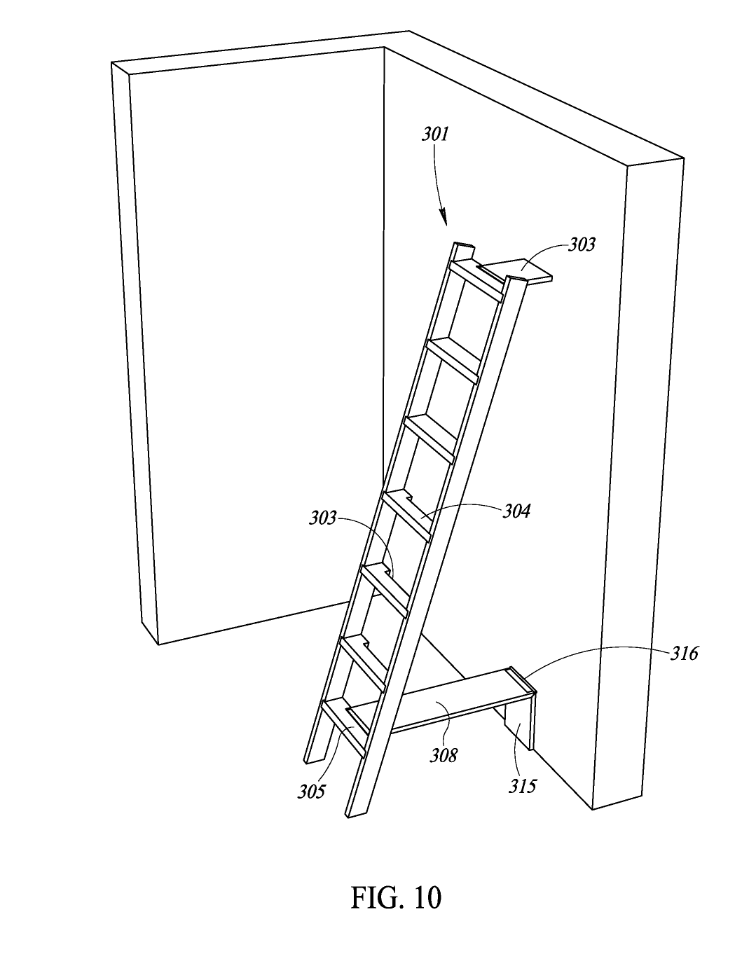

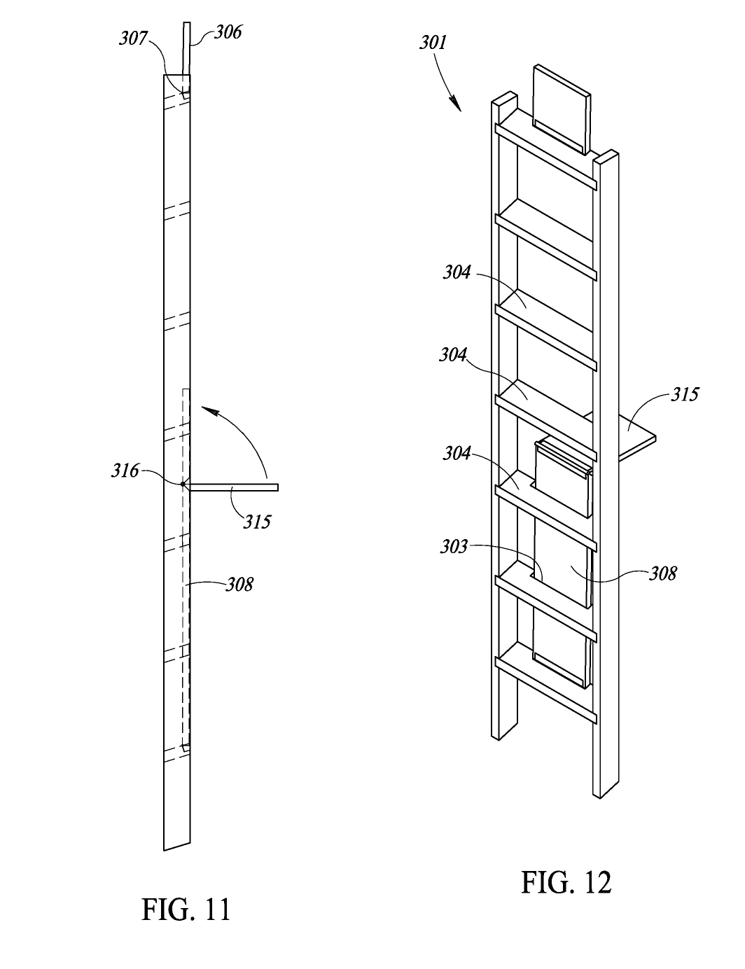

To further reduce the risk of tipping and sliding when not using bracket assemblies, an embodiment is shown in FIGS. 10-12 that provides a ladder 301 with many of the features of the ladder 201 (FIGS. 6 and 8). However, the ladder 301 includes a third support 315 coupled to a second support 308 by a hinge or rotation member 316. When in use, as in FIG. 10, the third support 315 rotates about the hinge or rotation member 316 to a position substantially transverse to a top surface of the second support 308 to provide additional support for the ladder 301. The hinge or rotation member 316 also includes a stabilizing feature that prevents the third support from rotating beyond this position, such that the third support 308 is relatively fixed in place by the hinge or rotation member 316 during use. When not in use, as in FIGS. 11 and 12, the third support 315 rotates about the hinge or rotation member 316 to a position substantially parallel to the top surface of the second support 308. The second support 308 and a first support 303 are configured to to rotate to a position substantially aligned with the ladder 301, similar to other embodiments. The second support 308 and the third support 315 may also be received by notches 303 in at least one of a plurality of steps 304. The notches 303 have a width and a depth substantially similar to the width and the depth of the second support 308 and the third support 315 such that the second support 308 and the third support 315 are received by the notch 303 to further minimize the space required for storage of the ladder 301. This embodiment of the present disclosure provides the benefit of reducing risk of tipping or falling while also allowing for use without bracket assemblies, as disclosed in other embodiments.

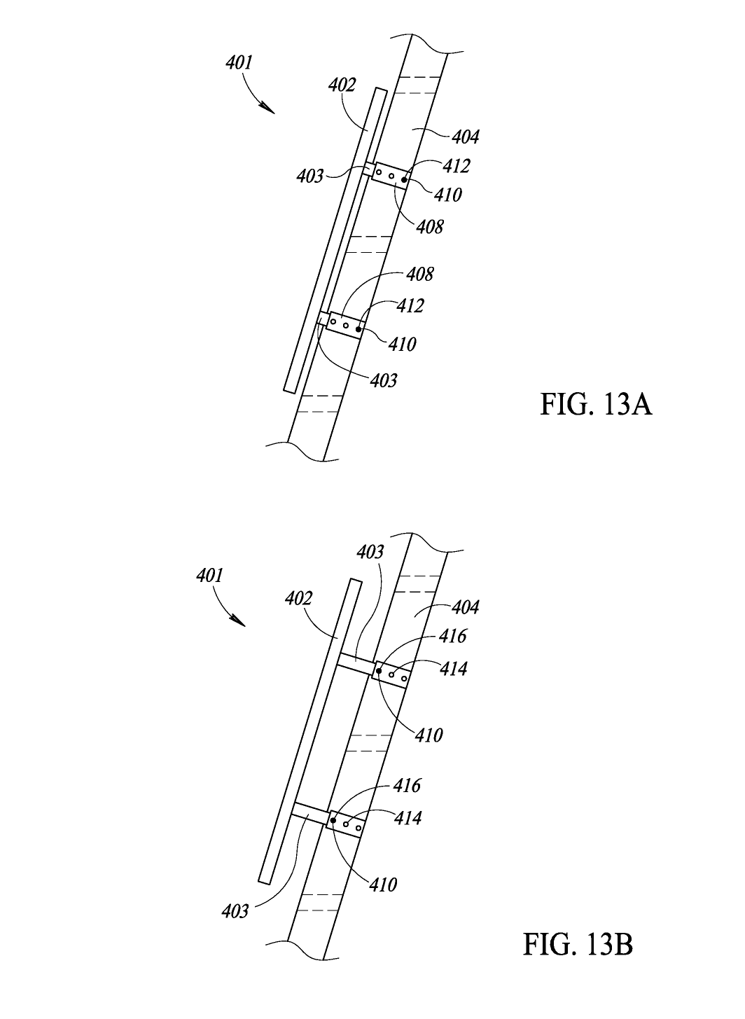

Circumstances may also arise where a user would find it beneficial to have a handrail attached to the ladder to assist the user as they climb up or down the ladder, which may be especially helpful when the ladder angle is steep, or the user has certain limitations that make climbing ladders difficult. To provide for a ladder with a stable handrail that does not increase the amount of space required for storage, FIGS. 13A and 13B show an embodiment of a ladder 401 with a handrail 402 coupled to a plurality of rods 403. The plurality of rods 403 are received by a plurality of rod supports 408 coupled to at least one rail 404 of the ladder 401. The plurality of rod supports 408 further include a plurality of holes 412, 414, 416 on each rod support configured to receive a push button 410 on each one of the plurality of rods 403.

When not in use, as in FIG. 13A, the push button 410 on the plurality of rods 403 is positioned in a lowest one 412 of the plurality of holes 412, 414, 416 such that the handrail 402 is positioned substantially adjacent to the rail 404 of the ladder 401. The plurality of holes 412, 414, 416 are configured to have a size and a shape substantially similar to the push button 410 such that the push button extends securely through the plurality of holes 412, 414, 416 and does not slip out of place during use. When in use, as in FIG. 13B, the user may press the push button 410 in to the plurality of rods 403 to remove the push button 410 from the lower one 412 of the plurality of holes 412, 414, 416 such that the handrail 402 translates away from at least one rail 404 of the ladder 401. After sliding the handrail 402, the push button 410 may release into an upper one 414, 416 of the plurality of holes 412, 414, 416 to secure the handrail 402 in place during use at a height that is comfortable for the user.

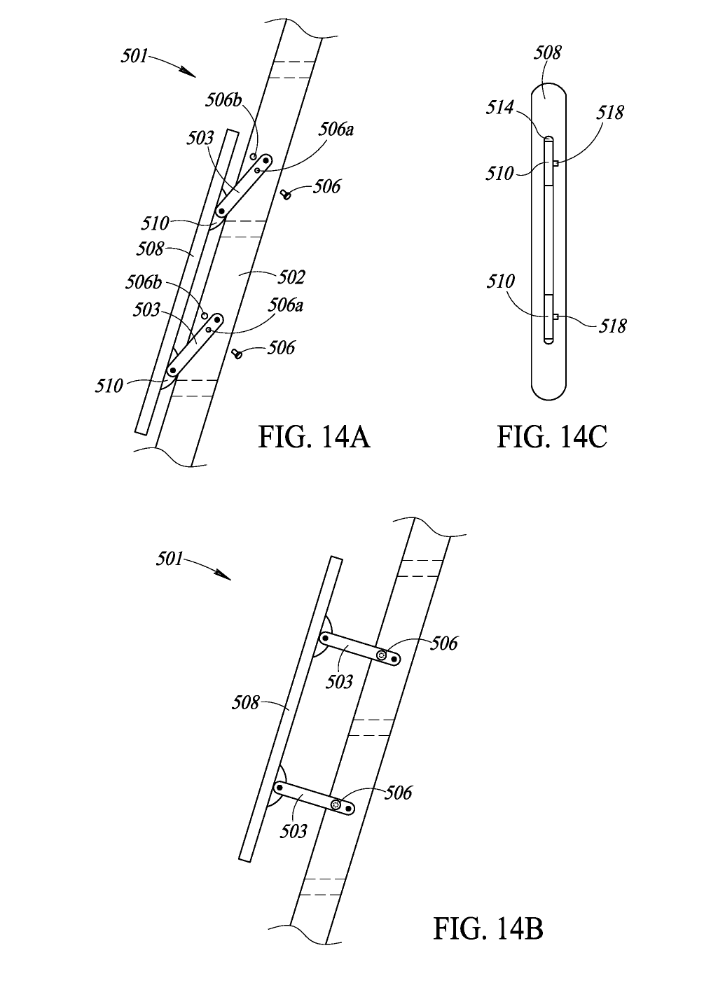

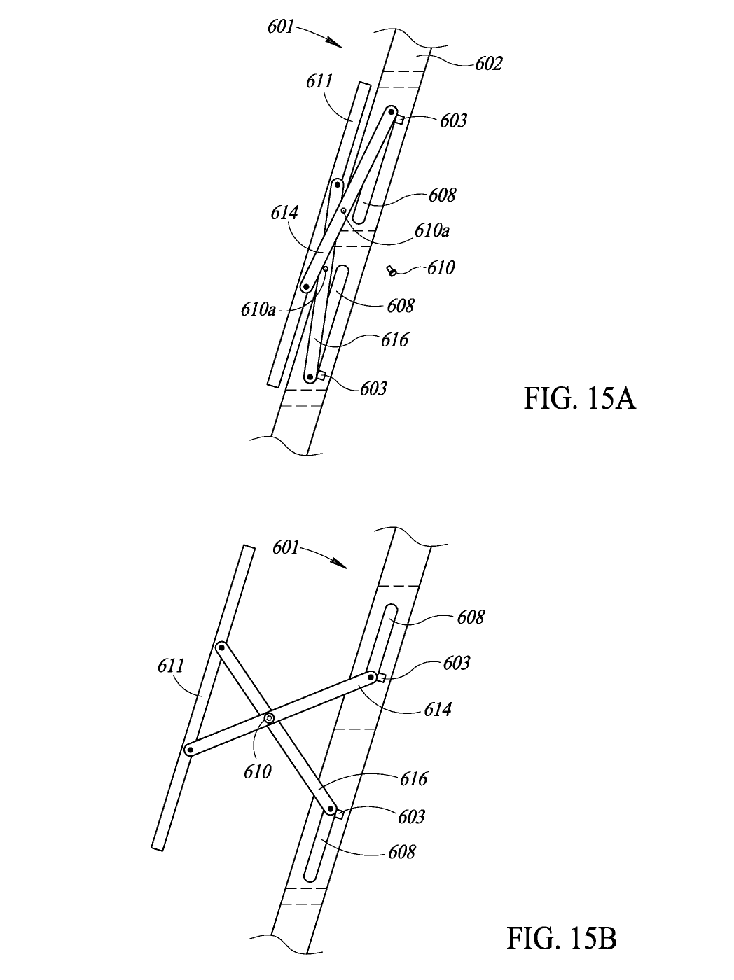

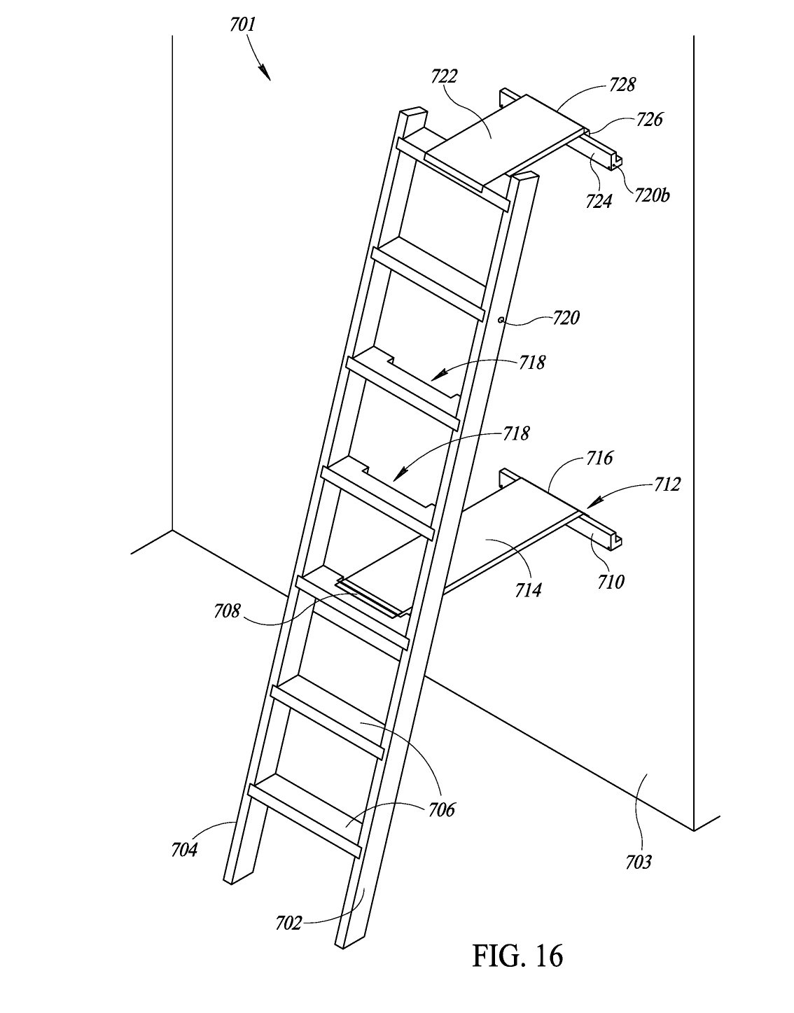

Another embodiment is shown in FIGS. 14A-14C wherein a ladder 501 includes a handrail 508 coupled to a plurality of sliding members 510. The plurality of sliding members are coupled to a plurality of translating bars 503 and the plurality of translating bars 503 are coupled to at least one rail 504 of the ladder 501. According to some embodiments, a first safety hole 506a can be provided in each of the plurality of translating bars 503 that is configured to align with a second safety hole 506b in at least one rail 504 of the ladder 501. The first safety hole 506a and the second safety hole 506b are configured to have a size and shape substantially similar to a plurality of securing pins 506 such that the first safety hole 506a and the second safety hole 506b receive the plurality of securing pins 506 to lock the handrail 508 in place during use.

When in the storage position, as in FIG. 14A, the plurality of securing pins 506 can be removed from the ladder 501. The plurality of translating bars 503 allow the handrail 508 to rotate to a position substantially adjacent to the ladder 501, thus minimizing the space required for storage. When in use, as in FIG. 14B, the plurality of translating bars 503 are rotated, along with the handrail 508, towards the top of the ladder 501. The plurality of securing pins 506 are then inserted to prevent the plurality of translating bars 503 from rotating beyond the desired position. In some embodiments, such as in FIG. 14C, an underside (i.e., a side facing away from the user and toward the wall) of the handrail 508 can include a groove 514 with a plurality of mechanisms 516 coupled to the plurality of sliding members 510. The plurality of mechanisms 516 are used with a plurality of releases 518 that allow the user to manipulate the plurality of releases 518 and slide the plurality of mechanisms 518 along the groove 514. As a result, the user can adjust the position of the handrail 508 with respect to the ladder 501, which further allows the handrail 508 to assist the user by being in the optimal position for support.

FIGS. 15A and 15B show a third exemplary embodiment of a ladder 601 with a handrail 611 coupled to a first crossing member 614 and a second crossing member 616. The first crossing member 614 and the second crossing member 616 are secured in a plurality of channels 608 a side of at least one rail 602 of the ladder 601. According to some embodiments, the first crossing member 614 and the second crossing member 616 may be moved along the plurality of channels 608 through manipulation of a plurality of braking members 603 and can include a safety pin 610 to secure the first crossing member 614 to the second crossing member 616 via a plurality of holes 610a that are configured to align on the first crossing member 614 and the second crossing member 616 and have a size and a shape substantially similar to the safety pin 610 such that the plurality of holes 610a can securely receive the safety pin 610 without the safety pin 610 releasing from the plurality of holes 610a.

To collapse the handrail, as in FIG. 15A, the user can remove the safety pin 610 and manipulate the plurality of braking members 603 such that the first crossing member 614 and the second crossing member 616 slide away from each other in the plurality of channels 608 and the handrail 611 comes to rest substantially adjacent to the ladder 601. While it may also be possible to use one channel rather than a plurality of channels 608, having separate channels allows for at least one rail 602 of the ladder 601 to provide additional support to the plurality of braking members 603 at the ends of the plurality of channels 608, thus further supporting the handrail 611. Further, the first crossing member 614 and the second crossing member 616 are coupled to the ladder 601 in a manner that allows movement of the first crossing member 614 and the second crossing member 616 once the plurality of braking members 603 are released from a lock position, with the first crossing member 614 overlapping the second crossing member 616 in a way that allows for free movement of both members.

When in use, the user can manipulate the plurality of braking members 603 to release the first crossing member 614 and the second crossing member 616 such that the user can slide the members toward each other in the plurality of channels 608. As the first crossing member 614 and the second crossing member 616 move towards each other, the handrail 611 is raised away from the ladder 601. By providing for the plurality of braking members 603 that can be secured anywhere along the plurality of channels 608, the handrail 611 is therefore adjustable to a comfortable height for the user. In some embodiments, the plurality of holes 610a will align on the first crossing member 614 and second crossing member 616 once the handrail 611 is in the fully raised position. Then, the user can insert the safety pin 610 into the plurality of holes 610a to lock the first crossing member 614 and the second crossing member 616 into place. In other embodiments, additional holes may be provided along the first crossing member 614 and the second crossing member 616 to provide additional locking locations along those members at different heights of the handrail 611.

The embodiments of FIGS. 13A, 13B, 14A-14C, 15A, and 15B provide the benefit of a handrail that is secured in place to assist the user in climbing up or down the ladder while being collapsible or foldable such that the space required for storage is greatly minimized, which reduces the risk of a user falling from the ladder without compromising the ease of storing the ladder. One skilled in the art will also appreciate that these and other possible handrail embodiments can be included with any of the ladder embodiments of the present disclosure.

Another alternative embodiment of a ladder 701 in a use position is shown in FIG. 16. In this embodiment, the ladder 701 includes a first rail 702 and a second rail 704 and a plurality of steps 706 coupled between the first rail 702 and the second rail 704. In one exemplary variation, the ladder 701 has a height ranging from six feet to eight feet and a width of approximately 20 inches. Accordingly, a width of each of the plurality of steps 706 is approximately 18 inches, with each of the steps 706 separated by a spacing of approximately 12 inches from a top surface of a first step to a top surface of a second step. In another variation, the steps 706 are angled at approximately 17 degrees, such that when the ladder is in the use position, the steps 706 are substantially parallel with the ground or other surface supporting the ladder 701 and the first and second rails 702, 704 are angled approximately 17 degrees from vertical. In yet other variations, the angle and dimensions vary to accommodate differing design requirements.

When in the use position, a first support member 714 is coupled on a first end to a first support brace 712 by a first hinge 716. The first hinge 716 allows for the first support member 714 and the first support brace 712 to rotate between the use position and a storage position. Similarly, the first support member 714 is coupled on a second end to one of the plurality of steps 706 with a second hinge 708 that may operate similarly to the first hinge 714. The first support brace 712 is coupled to a first bracket assembly 710 via a pin or bolt. Although the pin or bolt and the first support brace 712 are hidden in this view, they will be discussed in more detail with reference to the following figures. The first bracket assembly 710 has a size and a shape configured to receive the first support brace 712. One or more of the plurality of steps 706 includes a channel, opening, or groove 718 with a size and a shape configured to receive the first support member 714 or second support member 722 when the ladder 701 is in the storage position.

A second support member 722 is coupled on a first end to a second support brace 726 with a third hinge 728. The second support member 722 is coupled on a second end to one of the plurality of steps 706. The second support brace 726 is coupled to a second bracket assembly 724 and secured in place by a second pin or bolt. As would be understood by one of skill in the art, the first support member and the second support member 714, 722 may each independently be coupled to the ladder 701 using any mechanism described in the present disclosure.

The ladder 701 also includes at least one hole 720 for receiving the pin or bolt when the ladder 701 is rotated to a storage position. Each of the first bracket assembly 710 and the second bracket assembly 724 are coupled to a surface, such as a wall 703, that is capable of supporting the combined weight of the user, the ladder 701, and any object carried by the user up the ladder 701. Any suitable means for securing the first and second bracket assemblies 710, 724 to the wall 703 may be used. In some embodiments, the first and second bracket assemblies 710, 724 are secured to the wall 703 with 3/16″×4″ toggle bolts or 3½″ star drive screws.

In the use position, the coupling of the first support brace 712 with the first bracket assembly 710 and the second support brace 726 with the second bracket assembly 724 with pins or bolts provides for a stable ladder that will not slip or fall away from the wall 703 during use. In addition, the second support member 722 provides a platform for placing objects before or after climbing the ladder 701. Allowing for storage of objects during use prevents the user from having to climb the ladder with an object in hand, which substantially reduces the risk that the user or the object will fall from the ladder.

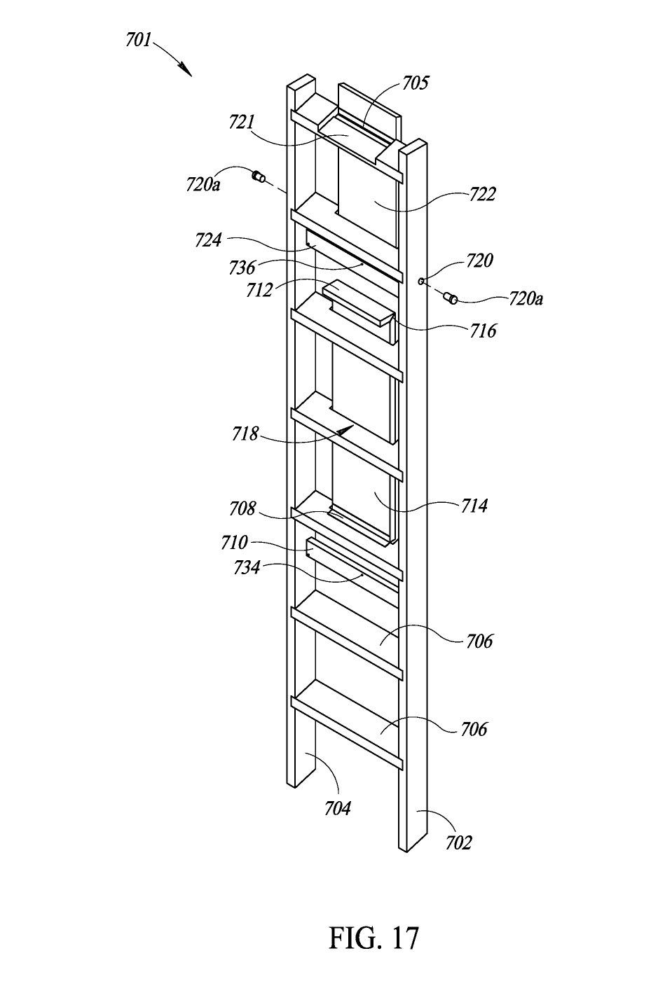

The ladder 701 can be rotated from the use position to the storage position to minimize the space required for storing, as in FIG. 17. To move the ladder 701 from the storage position to the use position, a user removes one or more bolts 720a that extend through the first and second rails 702, 704 into the first and second bracket assemblies 710, 724, respectively. The ladder 701 is then rotated into the use position and the first support brace 712 is then coupled with the first bracket assembly 710. After the first and second support braces 712, 726 are properly positioned, the bolts 720a are inserted into holes 734, 736. The bolts 720a keep the first support brace 712 and the second support brace 726 locked in place with the first bracket assembly 710 and the second bracket assembly 724, respectively, during use. Any suitable securing mechanisms may be used. In one embodiment, the bolts are 3½ inch metal door hinge pins.

To move the ladder 701 from the use position to the storage position, the bolts 720a are removed from holes 734, 736, and the user releases the first support brace 712 from its coupling with the first bracket assembly 710. After the first support brace 712 is removed, the user rotates the first support member 714 at the first hinge 716 and the second hinge 708 until the first support member 714 rests in the groove 718 in at least one of the steps 706. Unlike the first support brace 712, the second support brace is not removed from the second bracket assembly 724 for storage. However, the user still removes the bolt 720a from the second bracket assembly 724 such that the second support brace is no longer secured to the bracket assembly. After removing the bolt 720a from the second bracket assembly 724, the second support member 722 rotates at the third hinge 728 and a fourth hinge 705 which is coupled to an upper one of the plurality of steps 706 and the second support member 722. In one embodiment, the fourth hinge 705 is a piano hinge. Rotating the second support member 722 exposes a second groove or channel 721 with a size and shape to receive a portion of the second support member 722 when the ladder 701 is in the use position.

After the respective members have been rotated, the user inserts the bolts 720a into holes 720 in a side of the first rail 702 and the second rail 704. Inserting the bolts 720a in holes 720 secures the ladder in the storage position to ensure that the ladder does not fall during storage.

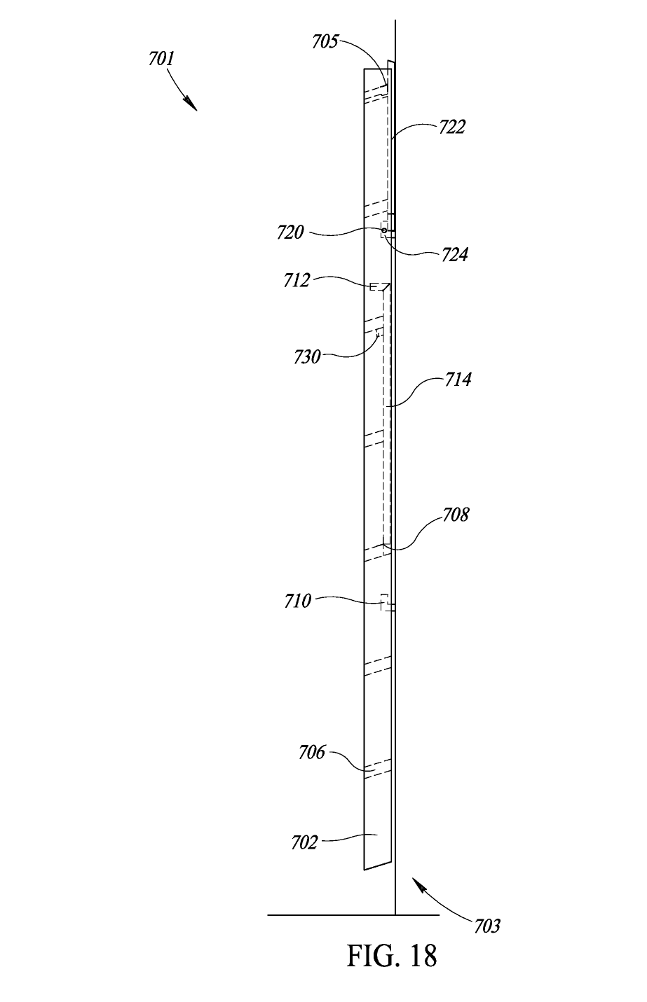

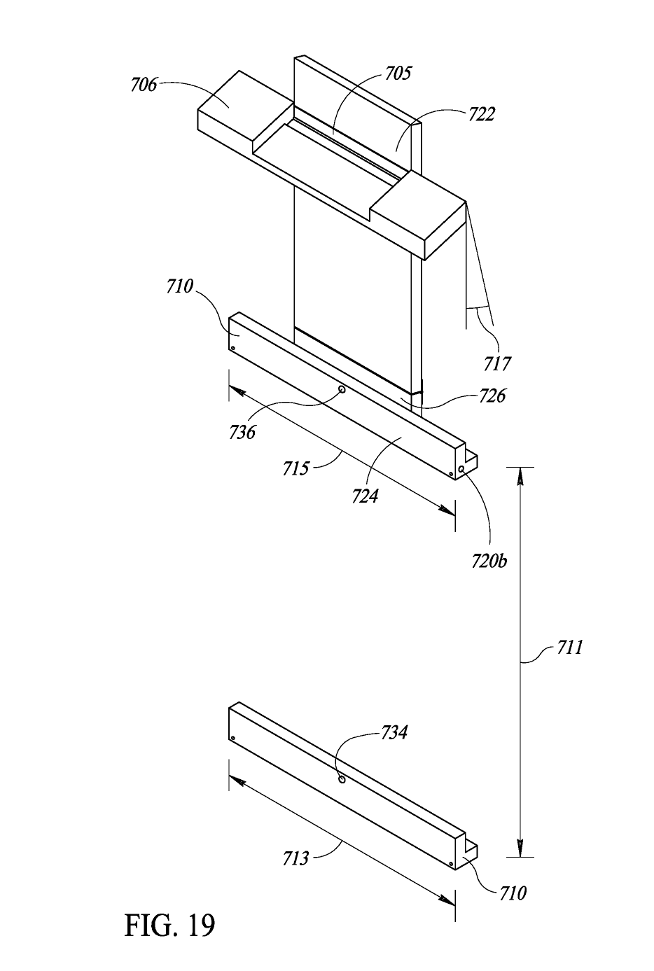

In addition, the hole 720 in the first rail 702 is shown in more detail in FIG. 18. The hole 720 extends through the first rail 702 and aligns with hole 720b (shown in FIG. 19) in a body of the second bracket assembly. When a user wishes to secure the ladder in the storage position, the user inserts a bolt or pin (shown as 720a in FIG. 17) into the hole 720 and a corresponding hole 720b (as shown in FIG. 19) in the second bracket assembly so that the ladder cannot move from the storage position. In an alternative embodiment, a similar hole may be placed in the first bracket assembly 710 and at a second location in the first rail 702 corresponding to the hole in the first bracket assembly. This arrangement would provide added security to the storage position.

Further in the storage position, as shown FIG. 18, the first and second support members 714, 722 are substantially aligned with the first and second rail 702, 704, which reduces the space required for storage. If the user chooses not to store the ladder 701 above the bracket assemblies 710, 724, the ladder 701 can be moved away and stored in a separate location. Then, the user can hang a picture, a mirror, or other decor over the bracket assemblies 710, 724 to minimize their impact in the home.

In this embodiment, the ladder 701 is secured against the wall 703 or other mounting surface. The first support member 714 and the second support member 722 are substantially aligned with a peripheral edge of the first rail 702. In addition, a clasp 730, which may be of a magnetic or a hook and loop type, is coupled to one of the plurality of steps 706. The corresponding portion of the clasp 730 is coupled to the first support member 714 such that when the ladder 701 is in the storage position, the first support member 714 is securely coupled to the clasp 730. The second support member 722 does not require a similar clasp because of the coupling between the second support member 722 and one of the plurality of steps 706 with the fourth hinge 705. In some embodiments, all of the hinges are the same type. In one embodiment, the hinges are 9 inch nickel plated piano hinges. As would be understood by one of ordinary skill, other suitable hinges may be used.

FIG. 19 shows an enhanced view of the first and second bracket assemblies 710, 724 to provide additional detail about features that are hidden in other views. In this embodiment, the second bracket assembly 724 has a hole 720b, which aligns with the hole 720 (shown in FIG. 18) and has a size and a shape configured to receive a pin or bolt 720a, which secures the ladder in the storage position. In addition, the second bracket assembly has a hole 736 for receiving the pin or bolt 720a when the ladder is in use. The hole 736 extends through the second bracket assembly 724 and into the second support brace 726 in order to lock the second support member 722 in place when the ladder is in the use position. Similarly, the first bracket assembly 710 includes a hole 734 for receiving the second bolt 720a. The hole 734 extends through the first bracket assembly 710 and into the first support brace (not shown), which allows the user to lock the first support member in place during use.

The first bracket assembly 710 has a width 713 and the second bracket assembly 724 has a width 715. The first and second bracket assemblies 710, 724 are separated by a height 711. In one embodiment, the widths 713, 715 are 18 inches and the height 711 is three feet. As would be understood by one of ordinary skill, although other dimensions are possible and the widths 713, 715 may be different. In addition, FIG. 19 shows that the steps 706 have an angle 717. In one variation, the angle 717 is approximately 17 degrees such that when the ladder is in the use position, the ladder is approximately 17 degrees from vertical and the steps 706 are substantially horizontal with the ground or other supporting surface. This allows the user to easily climb the steps with a lower risk of slipping or falling. The risk of slipping or falling may be further reduced by adding a non-slip coating, such as a stick-on sand paper to a contact surface of each of the steps 706.

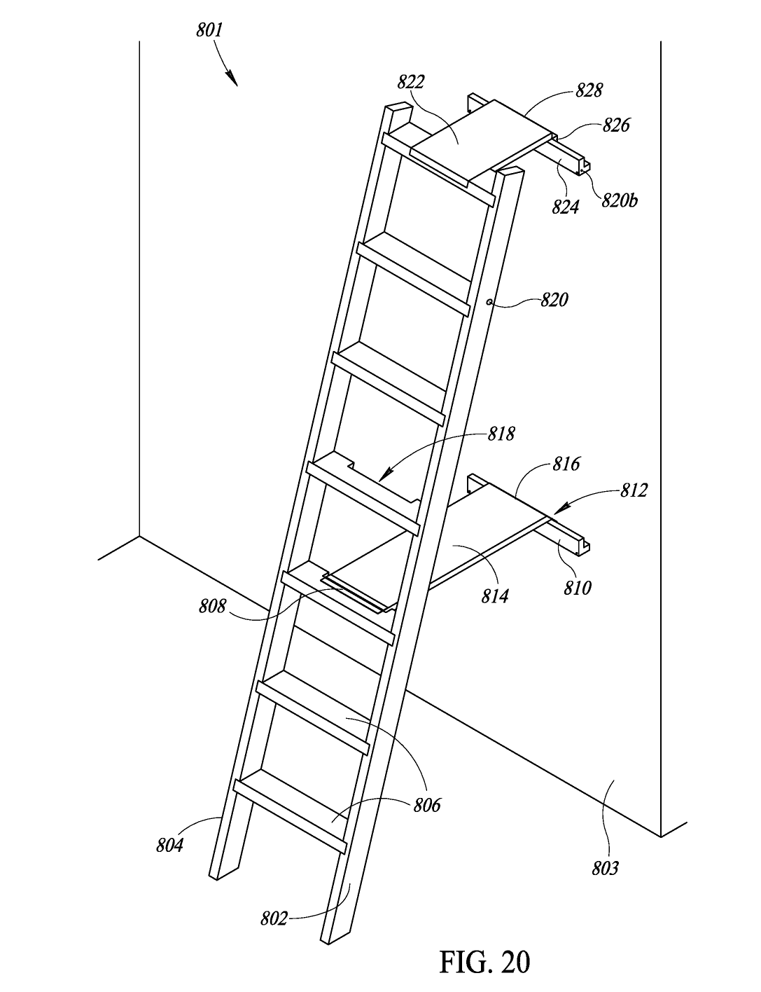

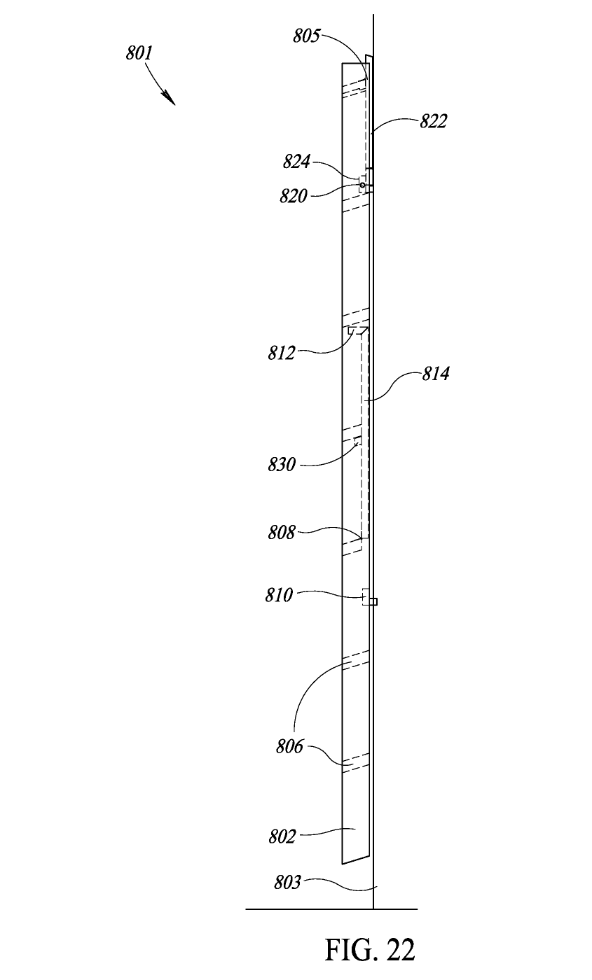

A further embodiment of the present disclosure is shown in FIGS. 20-22.

In this embodiment, the ladder 801 includes a first rail 802 and a second rail 804 and a plurality of steps 806 coupled between the first rail 802 and the second rail 804. In some embodiments, the steps 806 are angled at approximately 17 degrees, such that when the ladder is in the use position, the steps 806 are substantially parallel with the ground or other surface supporting the ladder 801 and the first and second rails 802, 804 are angled approximately 17 degrees from vertical.

When in the use position, a first support member 814 is coupled on a first end to a first support brace 812 by a first hinge 816. The first hinge 816 allows for the first support member 814 and the first support brace 812 to rotate between the use position and a storage position. Similarly, the first support member 814 is coupled on a second end to one of the plurality of steps 806 with a second hinge 808 that may operate similarly to the first hinge 814. The first support brace 812 is coupled to a first bracket assembly 810 via a pin or bolt. The first bracket assembly 810 has a size and a shape configured to receive the first support brace 812. One or more of the plurality of steps 806 includes a channel, opening, or groove 818 with a size and a shape configured to receive the first support member 814 or second support member 822 when the ladder 801 is in the storage position.

A second support member 822 is coupled on a first end to a second support brace 826 with a third hinge 828. The second support member 822 is coupled on a second end to one of the plurality of steps 806. The second support brace 826 is coupled to a second bracket assembly 824 and secured in place by a second pin or bolt. The rails 802, 804 also include at least one hole 820 for receiving the pin or bolt when the ladder 801 is rotated to a storage position.

Each of the first bracket assembly 810 and the second bracket assembly 824 are coupled to a surface, such as a wall 803, that is capable of supporting the combined weight of the user, the ladder 801, and any object carried by the user up the ladder 801. Any suitable means for securing the first and second bracket assemblies 810, 824 to the wall 803 may be used, such as 3/16″×4″ toggle bolts or 3½″ star drive screws.

In the use position, the coupling of the first support brace 812 with the first bracket assembly 810 and the second support brace 826 with the second bracket assembly 824 with pins or bolts prevents the ladder from slipping or falling away from the wall 803 during use. In addition, the second support member 822 provides a platform for placing objects before or after climbing the ladder 801. Allowing for storage of objects during use substantially reduces the risk that a user or an object being carried or used will fall from the ladder.

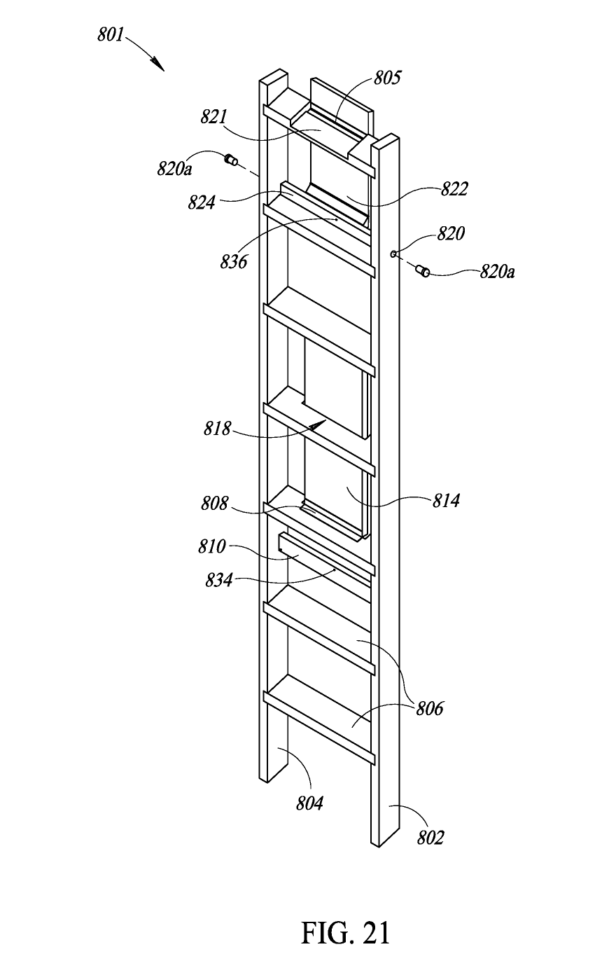

The ladder 801 can be rotated from the use position to the storage position to minimize the space required for storing, as in FIG. 21. To move the ladder 801 from the storage position to the use position, a user removes one or more bolts 820a that extend through the first and second rails 802, 804 into the first and second bracket assemblies 810, 824, respectively. The ladder 801 is then rotated into the use position and the first support brace 812 is then coupled with the first bracket assembly 810. After the first and second support braces 812, 826 are properly positioned, the bolts 820a are inserted into holes 834, 836. The bolts 820a keep the first support brace 812 and the second support brace 826 locked in place with the first bracket assembly 810 and the second bracket assembly 824, respectively, during use. Any suitable securing mechanisms may be used, such as 3½ inch metal door hinge pins.

To move the ladder 801 from the use position to the storage position, the bolts 820a are removed from holes 834, 836, and the user releases the first support brace 812 from its coupling with the first bracket assembly 810. After the first support brace 812 is removed, the user rotates the first support member 814 at the first hinge 816 and the second hinge 808 until the first support member 814 rests in the groove 818 in at least one of the steps 806. Unlike the first support brace 812, the second support brace may not be removed from the second bracket assembly 824 for storage. Regardless, the user would removes the bolt 820a from the second bracket assembly 824 such that the second support brace is no longer secured through hole 836 to the bracket assembly. After removing the bolt 820a from the second bracket assembly 824, the second support member 822 rotates at the third hinge 828 and a fourth hinge 805 (e.g., a piano hinge) which is coupled to an upper one of the plurality of steps 806 and the second support member 822. Rotating the second support member 822 exposes a second groove or channel 821 with a size and shape to receive a portion of the second support member 822 when the ladder 801 is in the use position.

After the respective members have been rotated, the user inserts the bolts 820a into holes 820 in a side of the first rail 802 and the second rail 804. Inserting the bolts 820a in holes 820 secures the ladder in the storage position to prevent the ladder from falling during storage.

As indicated in FIG. 21, hole 820 extends through the first rail 802 and aligns with hole in a body of the second bracket assembly. When a user wishes to secure the ladder in the storage position, the user inserts a bolt or pin (shown as 820a in FIG. 21) into the hole 820 and a corresponding hole in the second bracket assembly so that the ladder is held in the storage position. In an alternative embodiment, a similar hole may be placed in the first bracket assembly 810 and at a second location in the first rail 802 corresponding to the hole in the first bracket assembly. This arrangement would provide added security to the storage position.

Further in the storage position, as shown FIG. 21, the first and second support members 814, 822 are substantially aligned with the first and second rail 802, 804, which reduces the space required for storage. If the user chooses not to store the ladder 801 above the bracket assemblies 810, 824, the ladder 801 can be moved away and stored in a separate location. The user may then hide the bracket assemblies 810, 824 by hanging an article (e.g., a picture, poster, painting, etc.) to minimize the visual impact in the home.

In this embodiment, the ladder 801 is secured against the wall 803 or other mounting surface. The first support member 814 and the second support member 822 are substantially aligned with a peripheral edge of the first rail 802. In addition, a clasp 830 (e.g., a magnetic or a hook and loop), is coupled to one of the plurality of steps 806. The corresponding portion of the clasp 830 is coupled to the first support member 814 such that when the ladder 801 is in the storage position, the first support member 814 is securely coupled to the clasp 830. The second support member 822 may couple to a similar clasp. In some embodiments, all of the hinges are the same type. In one embodiment, the hinges are 9 inch nickel plated piano hinges. In other embodiments, one or more of the hinges may be of different types. As would be understood by one of ordinary skill, other suitable hinges may be used. Additionally, the embodiments shown in FIGS. 20-22 may have first and second bracket assemblies similar to those shown in FIG. 19.

The embodiments of the present disclosure in FIGS. 16-22 provide several additional benefits. For example, the first support member 714 is positioned at least one step higher (e.g., one step, two step, three steps, four steps, etc.), which results in less materials required for construction, a lower total weight, and also places the first support member 714 at an easier height for the user to move between the use and storage positions. These are important benefits particularly for users with decreased mobility. In addition, this configuration reduces the height 711 by which the first and second bracket assemblies 710, 714 are separated. This allows the first and second bracket assemblies 710, 714 to be more easily covered, for example, with a photo, poster, mirror, etc. In addition, coupling the second support member 722 directly to one of the steps 706 with the fourth hinge 705 provides increased strength and stability, as well as greater simplicity due to having fewer joints, no angle cuts, and reduction in the number of hinges required for construction. In the description, certain specific details are set forth in order to provide a thorough understanding of various embodiments of the disclosure. However, one skilled in the art will understand that the disclosure may be practiced without these specific details. In other instances, well-known structures have not been described in detail to avoid unnecessarily obscuring the descriptions of the embodiments of the present disclosure.

Unless the context requires otherwise, throughout the specification and claims that follow, the word “comprise” and variations thereof, such as “comprises” and “comprising,” are to be construed in an open, inclusive sense, that is, as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

As used in the specification and appended claims, the use of “correspond,” “corresponds,” and “corresponding” is intended to describe a ratio of or a similarity between referenced objects. The use of “correspond” or one of its forms should not be construed to mean the exact shape or size.

In the drawings, identical reference numbers identify similar elements or acts. The size and relative positions of elements in the drawings are not necessarily drawn to scale.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A ladder system, comprising:
a pair of rails;
a plurality of steps coupled between the pair of rails;
a first support member, the first support member including:
a first platform coupled to an upper one of the plurality of steps;
a first connection member coupled to the first platform; and
a first bracket assembly having a first receiving portion, the first receiving portion configured to receive the first connection member; and
a second support member, the second support member including:
a second platform coupled to a lower one of the plurality of steps;
a second connection member coupled to the second platform; and
a second bracket assembly having a second receiving portion, the second receiving portion configured to receive the second connection member.

2. The system of claim 1 wherein the first platform is configured to rotate from a first position substantially parallel to a top surface of the upper one of the plurality of steps to a second position substantially transverse to the top surface of the upper one of the plurality of steps.

3. The system of claim 1 wherein the first connection member is configured to rotate from a first position substantially parallel to a top surface of the first platform to a second position substantially transverse to the top surface of the first platform.

4. The system of claim 1 wherein the second platform is configured to rotate from a first position substantially parallel to a top surface of the lower one of the plurality of steps to a second position substantially transverse to the top surface of the lower one of the plurality of steps.

5. The system of claim 1 wherein the second connection member is configured to rotate from a second position substantially parallel to a top surface of the second platform to a second position substantially transverse to the top surface of the second platform.

6. The system of claim 1 wherein at least one of the first bracket assembly and the second bracket assembly are configured to couple to a support surface.

7. The system of claim 1 wherein the first support member includes a removable fastener, the pair of rails and the first bracket assembly configured to receive the removable fastener, the removable fastener configured to secure the pair of rails to the first bracket assembly.

8. The system of claim 1, further comprising:
a handrail coupled to the ladder system, the handrail configured to translate from a first position substantially adjacent to the pair of rails to a second position extended from the pair of rails.

9. The system of claim 1 wherein the upper one of the plurality of steps includes a first step support and the lower one of the plurality of steps includes a second step support, the first step support configured to receive the first platform and the second step support configured to receive the second platform.

10. The system of claim 1 wherein at least one of the plurality of steps includes an opening, the opening configured to be substantially similar to a width and a thickness of the second platform.

11. The system of claim 1 wherein at least one of the plurality of steps includes a fastener, the fastener configured to secure the second support member to at least one of the pair of rails or the plurality of steps.

12. The system of claim 1 wherein a top surface of the first bracket assembly and a top surface of the second bracket assembly are configured to receive the pair of rails and the plurality of steps.

13. A device, comprising:
a first rail positioned substantially parallel to a second rail;
a plurality of steps with a first end and a second end, the first end coupled to the first rail and the second end coupled to the second rail;
a first support coupled to a first one of the plurality of steps, the first support configured to rotate from a first position substantially parallel with a top surface of the first one of the plurality of steps to a second position substantially transverse to the top surface of the first one of the plurality of steps; and
a second support coupled to a second one of the plurality of steps, the second support configured to rotate from a first position substantially parallel with a top surface of the second one of the plurality of steps to a second position substantially transverse to the top surface of the second one of the plurality of steps.

14. The device of claim 13 wherein the first support is configured to have a width substantially similar to the first one of the plurality of steps and the second support is configured to have a width substantially similar to the second one of the plurality of steps.

15. The device of claim 13 wherein the second support includes a brace member, the brace member configured to couple the second support to at least one of the first rail and the second rail.

16. The device of claim 13 wherein the second support includes a third support coupled to the second support, the third support configured to rotate from a first position substantially parallel with a top surface of the second support to a second position substantially transverse to the top surface of the second support.

17. The device of claim 13 wherein the first one of the plurality of steps contains a first step support, the first step support configured to receive the first support, and the second one of the plurality of steps contains a second step support, the second step support configured to receive the second support.

18. The device of claim 13, further comprising:
a handrail coupled to at least one of the first rail and the second rail, the handrail configured to translate from a first position substantially adjacent to the pair of rails to a second position extended from the first rail and the second rail.

19. The device of claim 13 wherein at least one of the plurality of steps includes a notch, the notch configured to be substantially similar to a width and a thickness of the second support.

20. The device of claim 13 wherein at least one of the plurality of steps includes a clasp, the clasp configured to removably couple the second member to at least one of the plurality of steps.
